(19) United States
(12) Patent Application Publication
(10) Pub. No.: US 2024/0061123 A1
(43) Pub. Date: Feb. 22, 2024

(54) ELECTRONIC DEVICE AND METHOD

(71) Applicant: Sony Semiconductor Solutions Corporation, Atsugi-shi, Kanagawa (JP)

(72) Inventor: Yukinao KENJO, Stuttgart (DE)

(73) Assignee: Sony Semiconductor Solutions Corporation, Atsugi-shi, Kanagawa (JP)

(21) Appl. No.: 18/267,463

(22) PCT Filed: Dec. 17, 2021
(86) PCT No.: PCT/EP2021/086370

§ 371 Date: Jun. 15, 2023

(30) Foreign Application Priority Data
Dec. 22, 2020 (EP) 20216443.0

(51) Int. Cl. G01S 17/894

(52) U.S. Cl. CPC G01S 17/894

(57) ABSTRACT

An electronic device comprising circuitry configured to apply a reflectance sharpening filter to a reflectance image obtained according to an indirect Time-of-Flight, iToF, principle to obtain a filtered reflectance value for a pixel of the reflectance image.

### TECHNICAL FIELD

The present disclosure generally pertains to the field of Time-of-Flight imaging, and in particular to devices and methods for Time-of-Flight image processing.

### TECHNICAL BACKGROUND

A Time-of-Flight (ToF) camera is a range imaging camera system that determines the distance of objects by measuring the time of flight of a light signal between the camera and the object for each point of the image. Generally, a Time-of-Flight camera has an illumination unit that illuminates a region of interest with modulated light, and a pixel array that collects light reflected from the same region of interest.

In indirect Time-of-Flight (iToF), three-dimensional (3D) images of a scene are captured by an iToF camera, which is also commonly referred to as “depth map”, or “depth image” wherein each pixel of the iToF image is attributed with a respective depth measurement. The depth image can be determined directly from a phase image, which is the collection of all phase delays determined in the pixels of the iToF camera.

Although there exist techniques for determining depths, images with an iToF camera, it is generally desirable to provide techniques which improve the determining of depths images with an iToF camera.

### SUMMARY

According to a first aspect the disclosure provides an electronic device comprising circuitry configured to apply a reflectance sharpening filter to a reflectance image obtained according to an indirect Time-of-Flight, iToF, principle to obtain a filtered reflectance value for a pixel of the reflectance image.

According to a further aspect the disclosure provides a method comprising applying a reflectance sharpening filter to a reflectance image obtained according to an indirect Time-of-Flight, iToF, principle to obtain a filtered reflectance value for a pixel of the reflectance image.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows the basic operational principle of an indirect Time-of-Flight imaging system, which can be used for depth sensing or providing a distance measurement; and

FIG. 2 schematically illustrates the determination of the I and Q value based on a modulation signal of a light source, a reflected light signal and four demodulation signals;

FIG. 3 shows a flow chart of a full field (FF) iToF system processing which comprises determining a reflectance image and applying a sharpening filter on the reflectance image;

FIG. 4 shows an embodiment of the iToF imaging system of FIG. 1, operated as a spot ToF imaging system; and

FIG. 5 schematically illustrates an embodiment of a VCSEL illuminator comprising a vertical cavity surface emitting laser (VCSEL) array, column drivers and row enable switches for spot scanning illuminator;

FIG. 6a shows a flow chart of a spot ToF processing which comprises determining a reflectance image and applying a sharpening filter on the reflectance image;

FIG. 6b schematically shows a direct-global-separation algorithm applied to pixels of a spot pixel region;

FIG. 7 schematically illustrates in diagram, this wrapping problem of iToF phase measurements; and

FIG. 8 shows the flowchart of detecting a corrupted depth measurement of a pixel in a full field iToF system based on reflectance sharpening filter;

FIG. 9 shows the flowchart of detecting a corrupted depth measurement of a spot in a spot ToF system based on reflectance sharpening filter;

FIG. 10 schematically describes an embodiment of an iToF device that can implement the processes of detecting a corrupted depth measurement of a spot or a pixel in an iToF system;

FIG. 11 shows a confidence image captured with a spot ToF camera;

FIG. 12 shows a reflectance image captured with a spot ToF camera;

FIG. 13 shows a depth image captured with a spot ToF camera;

FIG. 14a shows I-Q values of pixels from a region of interest;

FIG. 14b shows multiplied I-Q values of pixels from a region of interest;

FIG. 15a shows a reflectance image of a region of interest before applying a reflectance sharpening filter; and;

FIG. 15b shows a reflectance image of a region of interest after applying a reflectance sharpening filter.

FIG. 15c shows a filtered reflectance value of spots.

### DETAILED DESCRIPTION OF EMBODIMENTS

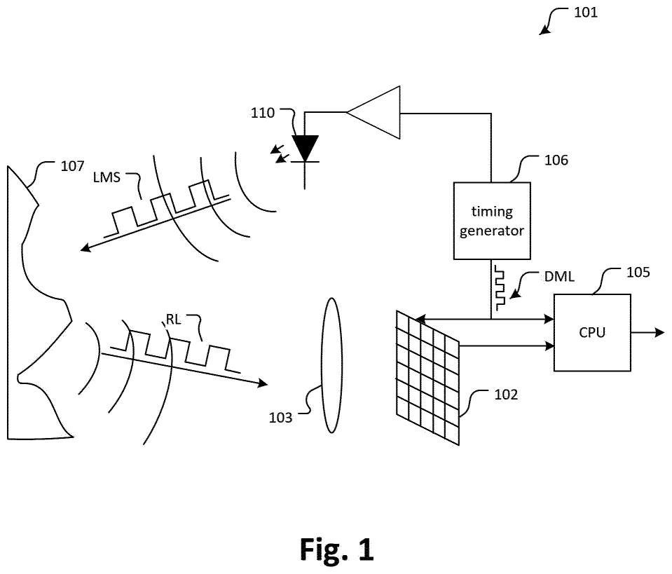

Before a detailed description of the embodiments under reference of FIG. 1, general explanations are made.

The embodiments described below in more detail disclose an electronic device comprising circuitry configured to apply a reflectance sharpening filter to a reflectance image obtained according to an indirect Time-of-Flight, iToF, principle to obtain a filtered reflectance value for a pixel of the reflectance image.

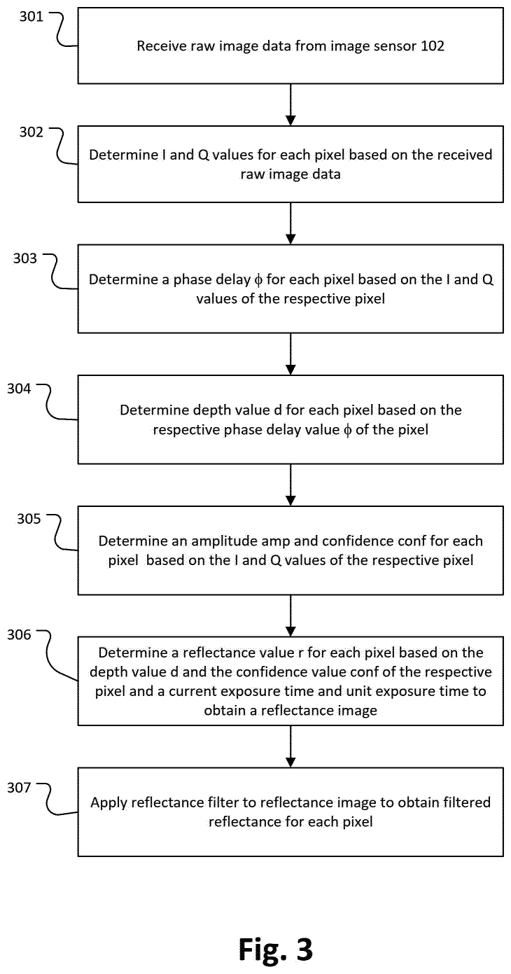

The indirect Time-of-Flight principle may be the principle of measuring a distance to an object by measuring a phase delay between an emitted light wave and a reflected/captured light wave as described for example in FIGS. 1 and 3. The indirect Time-of-Flight principle may also be a spot ToF principle.

Circuitry may include a processor, a memory (RAM, ROM or the like), a DNN unit, a storage, input means (mouse, keyboard, camera, etc), output means (display (e.g. liquid crystal, (organic) light emitting diode, etc.), loudspeakers, etc., a (wireless) interface, etc., as it is generally known for electronic devices (computers, smartphones, etc).

This electronic device may allow for more effective removal of noisy pixels than existing methods.

According to some embodiment the circuitry may be configured to decide based on the filtered reflectance value of the pixel whether a depth measurement of the pixel is false or not.

According to some embodiment the circuitry may be configured to decide that a depth measurement of the pixel is false if the filtered reflectance value of the pixel is below zero.

The depth measurement of the pixel may result from an iToF sensor. The depth measurement of the pixel may be false of a unwrapping error has occurred, or if a lens scattering has occurred.

According to some embodiment the circuitry may be configured to determine a confidence for the pixel, and to decide whether a depth measurement of the pixel is false or not based on the filtered reflectance value of the pixel and based on the confidence of the pixel.

According to some embodiment the circuitry may be configured to decide that a depth measurement of the pixel is false if the confidence of the pixel is below a predetermined threshold and if the filtered reflectance value of the pixel is below zero.

The confidence value may be compared to the threshold at first and if the confidence value is below the threshold the filtered reference value may be compared to zero second.

According to some embodiment the circuitry may be configured to invalidate a depth measurement of the pixel based on the filtered reflectance value of the pixel.

Invalidate may mean setting the depth, value of the pixel to zero, or to a predetermined value, or to the value of neighboring pixels of the pixel.

According to some embodiment the filtered reflectance value of the pixel may be determined based on the reflectance values of pixels in the reflectance image, and a predetermined sharpening factor.

According to some embodiment applying the sharpening filter to the reflectance image comprises determining a mean reflectance of pixels of the reflectance image in the neighborhood of the pixel.

The neighborhood of the pixel, i.e. the considered pixel, may be defined by a kernel of the reflectance sharpening filter. The n neighborhood of the pixel may be given by a matrix of pixels around the considered pixel. The matrix around the considered pixel may be centered at the considered pixel.

According to some embodiment the reflectance sharpening filter is determined as

$$\tilde{r} = r + α ( r - \frac{1}{N} {\sum }_{j ∈ Ω} {r}_{j} ) ,$$

wherein r is the reflectance value of a pixel in the reflectance image, \tilde{r} is the filtered reflectance value of this pixel, α is a predetermined sharpening factor, Ω is a kernel of the reflectance sharpening filter, N=|Ω| is the number of elements within the kernel Ω of the reflectance, and rⱼ are the reflectance values of pixels j within the reflectance image.

The kernel of the reflectance sharpening filter may be a matrix of pixels around the considered, pixel. The matrix around the considered, pixel may be centered at the considered pixel.

According to some embodiment the circuitry is further configured to identify spots captured by an iToF sensor, and wherein each pixel of the reflectance age (r) is associated with a respective spot of the spots captured by the iToF sensor.

A spot may be any (small) area visibly different amplitude from the surrounding area, for example a high intensity (with regards to amplitude) area. The spot may for example have a rectangular shape (with straight or round edges) a spot shape or the like.

An amplitude image may be obtained by from a raw image captured by the iToF sensor. The spot may be identified by a local maximum filter applied to the amplitude image which may yield a spot region. Each spot may be associated to one pixel, wherein this pixel may be defined in a spot domain. The spot domain may comprise pixels wherein each pixel in the spot domain represents a spot. The transformation from the pixel domain (i.e. the space where each pixel corresponds to a pixel of the image sensor) to the spot domain may be done by applying a local maximum filter. Each of the pixels in the spot domain may be associated with one amplitude/confidence/depth/reflectance value, which represents the amplitude/confidence/depth/reflectance value of that spot. The amplitude/confidence/depth/reflectance value may be determined by taking a respective amplitude/confidence/depth/reflectance value of a spot peak value of the respective spot. The amplitude/confidence/depth/reflectance value may also be determined by taking a mean value of the respective amplitude/confidence/depth/reflectance value of the pixels comprised in the spot region of the respective spot.

According to some embodiment the circuitry may be further configured to identify spots captured by an iToF sensor, wherein the pixel is a spot peak pixel of a respective spot of the spots captured by the iToF sensor, and wherein the kernel of the reflectance sharpening filter comprises a predetermined number of spots wherein each spot corresponds to a spot peak pixel.

An amplitude image may be obtained by from a raw image captured by the iToF sensor. The spots may be identified by a local maximum filter applied to the amplitude image which may yield a spot region. Each spot may be associated to one pixel, wherein this pixel may be defined in a spot domain. The spot domain may comprise pixels wherein each pixel in the spot domain represents a spot. The transformation from the image sensor pixel domain (i.e. the space where each pixel corresponds to a pixel of the image sensor) to the spot domain may be done by applying a local maximum filter. Each of the pixels in the spot domain may be associated with one amplitude/confidence/depth/reflectance value, which represents the amplitude/confidence/depth/reflectance value of that spot. The amplitude/confidence/depth/reflectance value may be determined by taking a respective amplitude/confidence/depth/reflectance value of a spot peak pixel value of the respective spot.

The kernel of the reflectance sharpening filter may be defined in the spot domain and may comprise a number of spots which correspond to the pixels in, the spot domain.

The kernel of the reflectance sharpening filter may also be defined in image sensor pixel domain (i.e. the space where each pixel corresponds to a pixel of the image sensor) and may comprise a number of spot peak pixels which correspond to a respective spot.

According to some embodiment the circuitry is configured to invalidate all depth measurements related to a spot of the spots captured by an iToF sensor based on the filtered reflectance value of the pixel.

Invalidate all depth measurements related to a spot may mean that all depth values of the pixels (image sensor pixel domain) within the spot pixel region are set to zero, or to a predetermined value, or to the value of neighboring spot. Invalidate all depth measurements related to a spot may also mean that the depth value of the pixel related to the spot in the spot domain may be set to zero, or to a predetermined value, or to the value of neighboring pixel in the spot domain.

According to some embodiment the circuitry is configured to determine a confidence for the spot peak pixel, and to decide whether a depth measurement of the spot peak pixel is false or not if the confidence is below a predetermined threshold and the filtered reflectance value of the spot peak pixel is below zero.

Instead of the spot peak pixel a confidence of the spot may be determined by determining the mean confidence value of all pixels (in the image sensor space) within the spot region of the spot.

According to some embodiment the electronic device may further comprises an image sensor.

According to some embodiment the electronic device may further comprises a spot illuminator.

The embodiments described below in more detail disclose a method comprising applying a reflectance sharpening filter to a reflectance image obtained according to an indirect Time-of-Flight, iToF, principle to obtain a filtered reflectance value for a pixel of the reflectance image.

Embodiments are now described by reference to the drawings.

### Operational Principle of an Indirect Time-Of-Flight Imaging System (iToF)

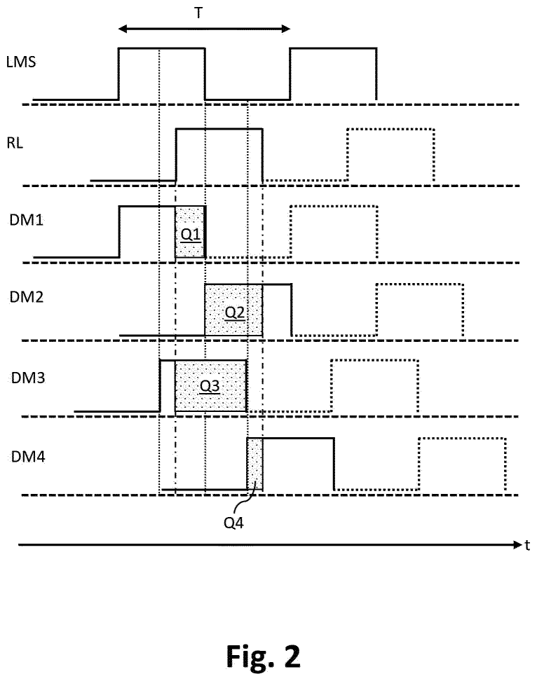

FIG. 1 schematically shows the operational principle of an indirect Time-of-Flight imaging system, which can be used for depth sensing or providing a distance measurement. The iToF imaging system 101 includes an iToF camera, for instance the imaging sensor 102 and a processor (CPU) 105. The scene 107 is actively illuminated with amplitude-modulated infrared light LMS at a predetermined wavelength using the illumination unit 110, for instance with some light pulses of at least one predetermined modulation frequency generated by a timing generator 106. The amplitude-modulated infrared light LMS is reflected from objects within the scene 107. A lens 103 collects the reflected light RL and forms an image of the objects onto an imaging sensor 102, having a matrix of pixels, of the iToF camera. In indirect Time-of-Flight (iToF) the CPU 105 correlates the reflected light RL with the demodulation signal DML which yields an in-phase component value (“I value”) for and quadrature component values (“Q-value”) for each pixel, so called I and Q values (see FIG. 2). Based on the I and Q values for each pixel a phase delay value may be calculated for each pixel which yields a phase image. Based on the phase image a depth value may be determined for each pixel which yields the depth image. Still further, based on the I and Q values an amplitude value and a confidence value may be determined for each pixel which yields the amplitude image and the confidence image.

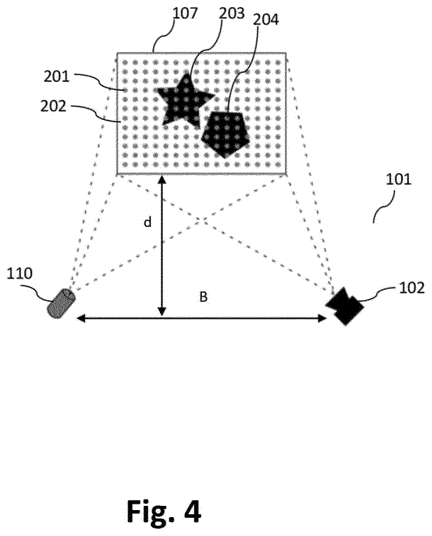

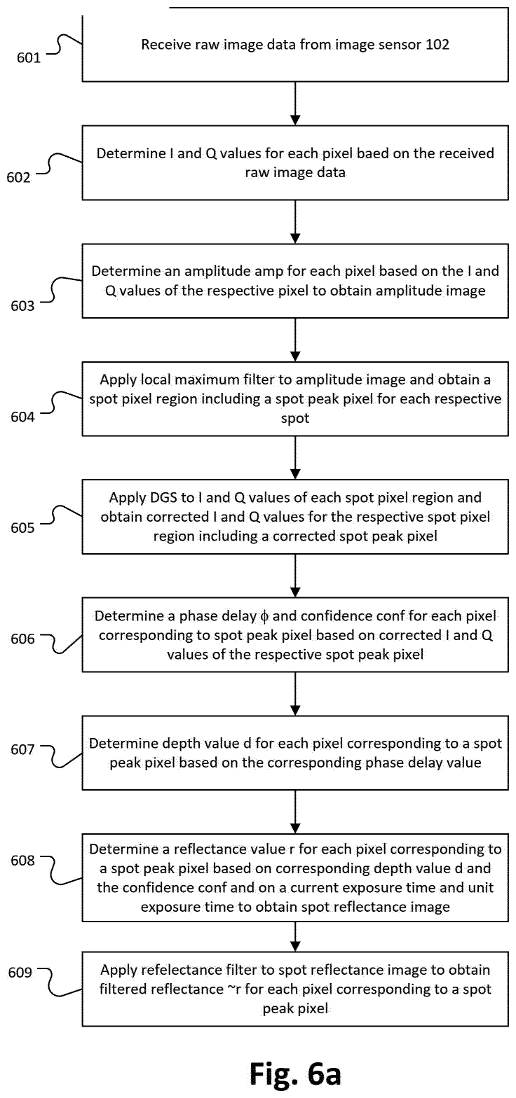

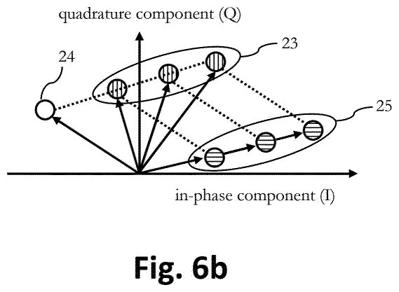

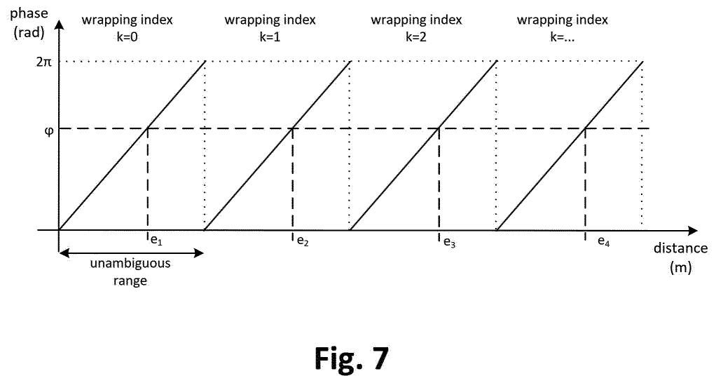

In a full field iToF system for each pixel of the image sensor 102 a phase delay value and a depth value may be determined. In a spot ToF system a scene may be illuminated with spots by a spot illuminator (see FIG. 4) and the phase a value and a depth value may only be determined for (a subset of) the pixels of the image sensor 102 which capture the reflected spots from the scene (see FIGS. 6 and 7).

FIG. 2 schematically illustrates the determination of the I and Q value based on a modulation signal of a light source, a reflected light signal and four demodulation signals. The modulation signal LMS of the illumination unit 110 is a rectangular modulation signal with a modulation period T. An intensity of emitted light of the light source is modulated in time according to the modulation signal LMS. The emitted light is reflected at an object in the scene 107. The reflected light signal RL is an intensity of the reflected light at the image sensor 102, which is phase-shifted with respect to the modulation signal LMS and varies according to the intensity-modulation of the emitted light. The phase is proportional to a distance to the object in the scene. The image sensor 102 captures four frames corresponding to the demodulation signals DM1, DM2, DM3 and DM4 which are all produced by the timing generator 106. The demodulation signal DM1 is phase-shifted by 0° with respect to the modulation signal LMS. When the demodulation signal DM1 is high, the image sensor 102 (each of the plurality of pixels) accumulates an electrical charge Q1 in accordance with an amount of light incident on the respective pixel and an overlap of the reflected light signal RL and the demodulation signal DM1. The demodulation signal DM2 is phase-shifted by 90° with respect to the modulation signal LMS. When the demodulation signal DM2 is high, the image sensor 102 (each of the plurality of pixels) accumulates an electrical charge Q2 in accordance with an amount of light incident on the respective pixel and an overlap of the reflected light signal RL and the demodulation signal DM2. The demodulation signal DM3 is phase-shifted by 180° with respect to the modulation signal LMS. When the demodulation signal DM3 is high, the image sensor 102 (each of the plurality of pixels) accumulates an electrical charge Q3 in accordance with an amount of light incident on the respective pixel and an overlap of the reflected light signal RL and the demodulation signal DM3. The demodulation signal DM4 is phase-shifted by 270° with respect to the modulation signal LMS. When, the demodulation signal DM4 is high, the image sensor 102 (each of the plurality of pixels) accumulates an electrical charge Q4 in accordance with an amount of light incident on the respective pixel and an overlap of the reflected light signal RL and the demodulation signal DM4.

The electrical charges Q1, Q2, Q3 and Q4 are proportional to, e.g., a voltage signal (electric signal) of the respective pixel of the image sensor 102 from which the pixel values are obtained and output by the image sensor 102 and, thus, the electrical charges Q1, Q2, Q3 and Q4 are representative for the pixel values.

The phase delay value ϕ is given by:

$$ϕ = arctan ( \frac{Q 3 - Q 4}{Q 1 - Q 2} ) = arctan ( \frac{Q}{I} ) \qquad Eq . ( 1 )$$

Q=Q3−Q4,

I=Q1−Q2

Here, Q is the quadrature component and I is the in-phase component, which are together I and Q values of the pixel.

Then, the distance d to the object is given by:

$$d = \frac{1}{2 π} \cdot {Z}_{Unambiguous} \cdot ϕ \qquad Eq . ( 2 )$$

wherein the (unambiguous) range Z_{Unambiguous} of an iToF sensor is given by:

$${Z}_{U n a m b i g u o u s} = \frac{c}{2 \cdot {f}_{m o d}} \qquad Eq . ( 3 )$$

with c being the speed, of light, and f_{mod} the modulation frequency. The distance d determined for each pixel yields the depth image

The amplitude amp of the light reflected signal RL is given by:

amp=\sqrt{I²+Q²} Eq. (4)

The confidence conf of the light reflected signal RL is given by:

conf=|I|+|Q| Eq. (5)

The amplitude amp and the confidence conf determined for each pixel yields the amplitude image respectively the confidence image.

### Reflectance Image

As stated above, an iToF sensor provides a phase image (ϕ), a confidence image (conf), and an amplitude image (amp) bases on the quadrature component Q and the in-phase component I provided by the pixels of the sensor.

The embodiments below make use of a so called “reflectance image” which can be determined based on the confidence image.

A reflectance value r may be determined as:

$$r = conf \cdot {d}^{2} \cdot \frac{unit\_exposure \_time}{current\_exposure \_time} \qquad Eq . ( 6 )$$

wherein d is the depth value of the pixel obtained from the depth image, unit_exposure_time is a predefined normalization exposure time of the image sensor, and current_exposure_time is the exposure time of the image sensor which was applied when capturing the raw image data. The predefined normalization exposure time of the pixel unit_exposure_time may for example be chosen as 1 ms.

Here, the factor d² in the determination of the reflectance takes account of the quadratic decrease of the intensity of radially emitted light with increasing distance, and the factor

$$\frac{unit\_exposure \_time}{current\_exposure \_time}$$

is foreseen tor normalization purposes and takes into account the dependency of the amount of light collected by the sensor from the exposure time applied when capturing an image.

The reflectance r determined for each pixel yields the reflectance image.

### Reflectance Sharpening

According to the embodiments described below, in more detail, a sharpening filter is applied to the reflectance image which yields a filtered reflectance value \tilde{r} for each pixel:

$$\tilde{r} = r + α ( r - \frac{1}{N} {\sum }_{j ∈ {Ω}_{f f}} {r}_{j} ) \qquad Eq . ( 7 )$$

wherein Ω_{ff} is the kernel of the filter for a full field (ff) (which means it is operated on all pixels of the sensor) iToF sensor, N=|Ω_{ff}| is the number of pixels within the kernel, and α is a predetermined sharpening filter constant, for example 1.010, wherein this parameter can be tuned with different conditions of scattering or different scenes (large α eliminates a large number of pixels around the edge of reflectance image). That means the reflectance sharpening filter is therefore controlled, by the two parameters, the sharpening filter constant α and the kernel size.

The above exemplifying sharpening filter is based on computing the mean value of all pixels j in the neighborhood (as defined by filter kernel Ω_{ff}) of the pixel. The size of the filter kernel Ω_{ff} may for example be chosen 9×9-17×17 pixels in an FF iToF system and it may comprise all pixels in a respective quadratic area around the pixel of the confidence image on which the sharpening filter is applied.

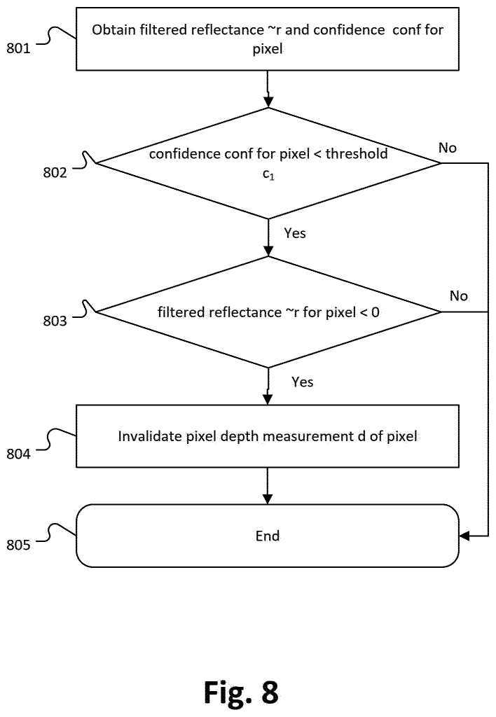

As described below (see FIG. 8) a filtered reflectance value \tilde{r} obtained by the reflectance sharpening filter may be used to detect and invalidate corrupted pixels, i.e. pixels whose depth measurement d is error-prone or false.

FIG. 3 shows a flow chart of a full field (FF) iToF system processing which comprises determining a reflectance image and applying a sharpening filter on the reflectance image. At 301, raw image data is received from an image sensor 102a. At 302, I and Q values, are determined for each pixel based on the received raw image data (see FIG. 2). At 303, a phase delay ϕ is determined for each pixel based on the I and Q values of the respective pixel. At 304, a depth value d (distance) for each pixel is determined based on the respective phase delay value ϕ of the pixel. At 305, an amplitude amp and confidence conf for each pixel is determined based on the I and Q values of the respective pixel. At 306, a reflectance value r for each pixel is determined based on the depth value d and the confidence value conf of the respective pixel and a current exposure time and unit exposure time to obtain a reflectance image. At 306, a reflectance filter is applied to the reflectance image to obtain a filtered reflectance \tilde{r} for each pixel.

### Spot Time-Of-Flight Imaging (spot ToF)

FIG. 4 schematically shows a spot ToF imaging system which produces a spot pattern on a scene 107. The spot ToF imaging system comprises a spot, illuminator 110, which produces a pattern 202 of spots 201 on a scene 107 comprising objects 203 and 204. An iToF camera 102 captures an image of the spot pattern on the scene 107. The pattern 202 of light spots 201 projected onto the scene 107 by illumination unit 110 results in a corresponding pattern of light spots in the amplitude image and depth image captured by the pixels of the image sensor (1021 in FIG. 1) of iToF camera 102. The light spots will appear in the amplitude image produced by iToF camera 102 as a spatial light pattern including high-intensity areas 201 (the light spots), and low-intensity areas 202. The spot illuminator 110 and the camera 102 are a distance B apart from each other. This distance B is called baseline. The scene 107 has distance d. However, every object 203, 204 or object point within the scene 107 may have an individual distance d from baseline B. The depth image of the scene captured by ToF camera 102 defines a depth value for each pixel of the depth image and thus provides depth information of scene 107 and objects 203, 204.

Typically, the pattern of light spots projected onto the scene 107, may result in a corresponding pattern of light spots captured on the pixels of the image sensor 102. In other words, spot pixel regions may be present among the plurality of pixels (and thus in the pixel values included in the obtained image data) and a valley pixel regions may be present among the plurality of pixels (and thus in the pixel values included in the obtained image data). The spot pixel regions (i.e. the pixel values of pixels included in the spot pixel regions) may include signal contributions from the light reflected from the scene 107 but also from background light, multi-path interference. The valley pixel region (i.e. the pixel values of pixels outside the spot pixel regions that are included in the valley pixel region) may include signal contributions from background light and from multi-path interference. Therefore, the CPU may apply a direct-global-separation algorithm (DGS) to the I and Q values to each spot, i.e. the pixels in inside a spot pixel region in order to reduce noise, for example from background light and from multi-path interference (see FIG. 6b).

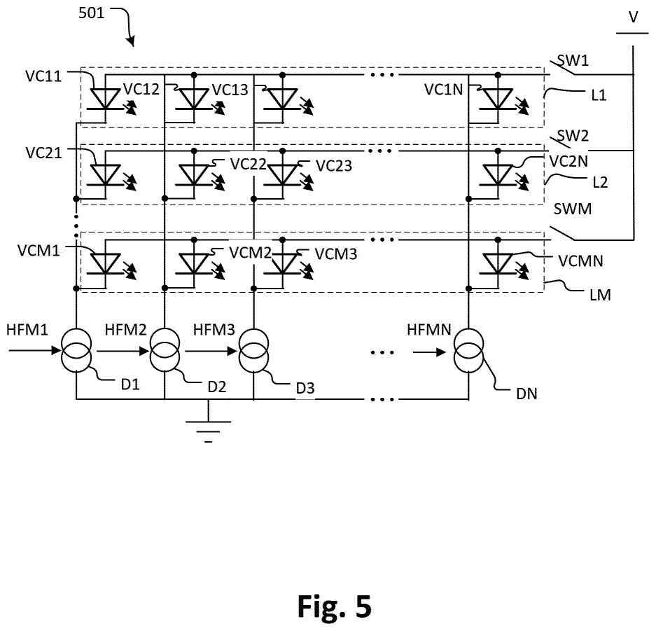

FIG. 5 schematically illustrates an embodiment of a VCSEL illuminator comprising a vertical cavity surface emitting laser (VCSEL) array, column drivers and row enable switches for spot scanning illuminator. The VCSEL illuminator (also called spot illuminator) 501 comprises an array of VCSELs VC1N-VCMN which are grouped in M sub-sets L1-LM, N drivers D1, D2, . . . , DN for driving the VCSEL array, and M switches SW1-SWM, where N and M may for example be a number between 2 to 16 or any other number. Each VCSEL VC1N-VCMN may have an illumination power of 2 W to 10 W. In this embodiment the sub-sets L1-LM are the rows of the VCSEL array. The VCSELs VC11, VC12, . . . , VC1N, VC14 of the first sub-set L1 are, grouped in the first electrical line zone. The VCSELs VC21, VC22, VC23, . . . , VC2N of the second sub-set L2 are grouped in the second electrical line zone. The VCSELs VC31, VC32, VC33, . . . , VC3N of the Mth sub-set LM are grouped in the third electrical line zone. Each electrical line zone is electrically connected to the respective driver D1, D2, . . . , DN and via the respective switches SW1-SWM to a supply voltage V. The supply voltage V supplies the power for generating a driving current, where the driving current is the current that is applied to the drivers D1, D2, . . . , DN and to the VCSEL array by turning on/off the respective switch SW1-SWM. Each driver D1, D2, . . . , DN receives a respective high modulation frequency signal HFM1, HFM2, . . . , HFMN to drive the VCSEL illuminator 401. Each controllable nodes of the illuminator 501 forms a spot beam, where the spot beams are not overlapping (not shown in FIG. 5). Each spot beam may for example have a different phase offset or all may have the same phase. A diffractive optical element (DOE) (not shown in FIG. 1) is disposed in front of the VCSEL array 501 in order to shape and split the VCSEL beams in an energy-efficient manner. A DOE may be a micro lens.

For example, the dot illuminator may produce 4000-5000 spots on the scene. The light spots may have a circle shape (for example spots) or rectangle/square shape or any other regular or irregular shape. The light pattern of spots may be a grid pattern or a line pattern or an irregular pattern.

### Reflectance Image in Spot Time of Flight

FIG. 6a shows a flow chart of a spot ToF processing which comprises determining a reflectance image and applying a sharpening filter on the reflectance image. At 601, raw data from image a sensor 102 is received. At 602, I and Q values for each pixel are determined as based on the received raw image data (see FIG. 2). At 603, an amplitude value and a confidence value for each pixel is determined based on the I and Q values of the respective pixel to obtain amplitude image and a confidence image. At 604, a local maximum filter (also called local maximum search) is applied to the amplitude image and a spot pixel region including a spot peak, pixel for each respective spot is obtained. In another embodiment the confidence may be used instead of the amplitude, wherein this may depend on the deformation of the received wave shape. For example if the shape is an ideal rectangle (see FIG. 2) then the confidence (i.e. a L1 norm) is preferred and if the shape is an ideal sin-wave the amplitude (i.e. a L2 norm) is preferred (however the difference may not be too significant since the image is only used for spot search using local maximum filter). The local maximum filter, which is generally known to the skilled person, determines the pixels among the pixels of the image sensor 102 which have an amplitude value corresponding to a local maximum, that is the spot peak pixels (“center of the spots”). That is the local maximum filter determines a pixel that corresponds to a spot peak pixel of a spot for each spot that was captured. Moreover, as the spatial light intensity profile of the plurality of light spots is known, the spatial amplitude profile also is basically known (or a principle shape of the spatial phase amplitude profile, since it, may be deformed in a case of saturation) and, thus, pixels which correspond to the spot pixel regions are determined by, applying the local maximum filter. Hence, also a pixel range of the spot pixel region is obtained, wherein the pixel range is or includes, for example, a number of pixels which belong to the spot pixel region. At 605, a direct-global-separation (DGS) is applied to I and Q values of each spot pixel region and corrected I and Q values are obtained for the respective spot pixel region including a corrected spot peak pixel (see FIG. 6b and corresponding description). At 606, a phase delay and confidence value are determined for each pixel corresponding to spot peak pixel based on corrected I and Q values of the respective spot peak pixel. At 607, a depth value for each pixel corresponding to a spot peak pixel is determined based on the corresponding phase delay value. At 608, a reflectance value for each spot (in the following “spot reflectance”) is determined based on the depth image and the confidence image to obtain a spot reflectance image. At 609, a sharpening filter is applied to the spot reflectance image to obtain a filtered reflectance \tilde{r} for each spot.

A spot reflectance value r_{S} of the spot domain reflectance image may for example be determined for each spot at 608 according to

$${r}_{S} = {conf}_{p e a k} \cdot {d}_{p e a k}^{2} \cdot \frac{unit\_exposure \_time}{current\_exposure \_time} \qquad Eq . ( 8 )$$

where confₚₑₐₖ and dₚₑₐₖ are the confidence value, and, respectively the depth value of a spot peak pixel of the spot, i.e. the pixel that has been identified at 604 by the local maximum filter as the maximum amplitude of the spot. In another embodiment dₚₑₐₖ is the result of the DGS in order to obtain an accurate depth avoiding multi-path interference. Thereby, more accurate reflectance information can be obtained.

Alternatively, a spot reflectance value r_{S} of the spot domain reflectance image may be determined by averaging confidence conf and depth d over all pixels i attributed to a spot Σ as identified at 604 by the local maximum filter:

$${r}_{S} = {conf}_{S} \cdot {d}_{S}^{2} \cdot \frac{unit\_exposure \_time}{current\_exposure \_time} \qquad Eq . ( 9 )$$

where

$$c o n {f}_{S} = 1 / N {\sum }_{i ∈ Σ} c o n {f}_{i} , and$$

$${d}_{S} = 1 / N {\sum }_{i ∈ Σ} {d}_{i} .$$

The spot domain reflectance image generated according to Eq. (8) thus comprises pixels, where each pixel relates to a spot identified by the local maximum filter and where each pixel defines a spot domain reflectance value r_{S} for a respective spot.

In the spot domain, the sharpening (see 609 of FIG. 6a) filter is applied to the reflectances in the spot domain reflectance image. That is, for each spot reflectance in the spot domain reflectance image a sharpened spot reflectance \tilde{r} is obtained according to:

$$\tilde{{r}_{S}} = {r}_{S} + α ( r - \frac{1}{N} {\sum }_{j ∈ {Ω}_{s}} {( {r}_{S} )}_{j} ) \qquad Eq . ( 10 )$$

wherein Ω_{S} is the kernel of a filter n the spot domain, N=|Ω_{S}| the number of spots in the kernel Ω_{S} and α is a predetermined sharpening filter constant.

For example, a kernel Ωₛ may comprise 15×15 spots arranged in a square around a center spot for which the reflectance [symbol] is determined. In this case, N=15²=225.

The light spots may have a spatial light intensity profile, for example, a Gaussian light intensity profile or the like. If, for example, a spot is assumed to comprise 7×7 pixels in the sensor domain, the kernel Ωₛ may correspond to 101×101 pixels in the pixel domain. Accordingly, the local maximum filter may for example be configured as a 7×7 filter.

FIG. 6b schematically shows a direct-global-separation (DGS) algorithm applied to pixels of a spot pixel region as performed at 605 in. FIG. 6a. Generally, the I-Q values of a pixel may be displayed in a coordinate system having the in-phase component I on the horizontal axis and the quadrature component Q on the vertical axis. Each pixel value of the spot pixel region IQ 23 (including the spot peak pixel) has a different phase, which is given by the angle of the arrow from the origin of coordinates to the respective IQ value, even though they belong to the same spot pixel region. A pixel 24 that is in the vicinity of the spot pixel region 23 but still outside of the spot pixel region, that is a valley pixel region value 24, is displayed in the coordinate system. Vicinity may be that a number of pixels between the valley pixel and the spot pixel region is equal or smaller than a number of pixels between the valley pixel and another spot pixel region. Here, the amplitude of the valley pixel region IQ value 24 (phase amplitude value), which is given by the length of the arrow from the origin of coordinates to the respective IQ value, may stem from background noise or multipath interference.

The phase of the spot pixel region IQ values 23 may be corrected (or accuracy may be improved) by subtracting the valley pixel region IQ value 24 from the spot pixel region IQ values 23, thereby corrected spot pixel region IQ values 25 are obtained. The pixels inside the corrected spot pixel region 25 may then have the same phase. Because the spot peak pixel is included in the spot pixel region, by applying the DGS to I and Q values of each spot pixel region a corrected I and Q value for the spot peak pixel of each spot is also obtained.

### False/Corrupted Depth Measurements

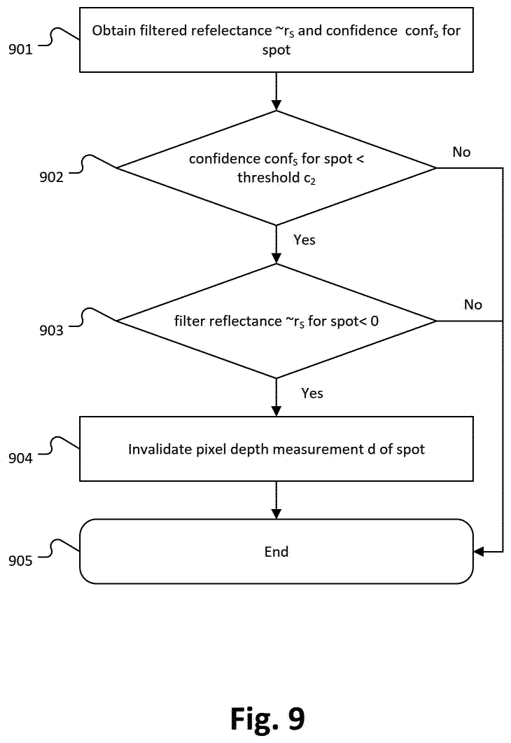

As described below (see FIG. 9) a filtered reflectance value \tilde{r} obtained by the reflectance sharpening filter may be used to detect and invalidate corrupted spots, that means spots whose depth measurement d is false (i.e. spots whose depth measurement of the spot peak pixels is false).

When determining the depth of an object with an iToF system there may be several potential sources for a corruption (falseness) of the depth measurement and cause a degradation of depth quality in iToF camera. For example, when determining the distance d corresponding to a phase delay value ϕ of a pixel a so-called wrapping problem or unambiguous problem may occur, which should be explained briefly in the following. As explained above, the distance is a function of the phase difference between the emitted and received modulated signal. This is a periodical function with period 2π, and different distances will produce the same phase measurement which is the wrapping problem or unambiguous problem. That is a phase measurement produced by the iToF camera is “wrapped” into a fixed interval, i.e., [0,2π], such that all phase values corresponding to a set {Φ|Φ=2kπ+φ, kϵZ} become φ, where k is called “wrapping index”. In terms of depth measurement, all depths are wrapped into an interval that is defined by the modulation frequency. In other words, the modulation frequency sets the unambiguous operating range Z_{Unambiguous} as described by:

$${Z}_{U n a m b i g u o u s} = \frac{c}{2 \cdot {f}_{m o d}}$$

with c being the speed of light, and f_{mod} the modulation frequency. For example, for an iToF camera having a modulation frequency 20 MHz, the unambiguous range is 7.5 m.

FIG. 7 schematically illustrates in diagram this wrapping problem of iToF phase measurements. The abscissa of the diagram represents the distance (true depth or unambiguous distance) between an iToF pixel and an object in the scene, and the ordinate represents the respective phase measurements obtained for the distances. The horizontal spotted line represents the maximum value of the phase measurement, 2π, and the horizontal dashed line represents an exemplary phase measurement value φ. The vertical dashed lines represent different distances e₁, e₂, e₃, e₄ that correspond to the exemplary phase measurement φ due to the wrapping problem. Thereby, any one of the distances e₁, e₂, e₃, e₄ corresponds to the same value of φ. The distance e₁ can be attributed to a wrapping index k=0, the distance e₂ can be attributed to a wrapping index k=1, the distance e₃ can be attributed to a wrapping index k=2, and so on. The unambiguous range defined by the modulation frequency is indicated in FIG. 2 by a double arrow and is 2π.

Another potential sources for a corruption of the depth measurement and cause of a degradation of depth quality in an iToF camera may be due to lens scattering cause be the lens 103 when capturing the reflected light RL with the image sensor 102 or due to un-focus issues.

The depth measurement of an iToF camera may be used to perform feature analysis or the like on the image. Therefore, the pixels or the spots (that may be the spot peak pixels corresponding to a spot) that a deliver a corrupted depth measurement d should be detected and invalidated, so that the feature detection algorithm or other applications that utilize the depth values determined by the iToF system do not make use of corrupted and false depth values

### Detection of Corrupted Pixels and Spots

A pixel which delivers a false depth measurement d is a corrupted pixel A spot whose pixel peak value delivered a wrong depth measurement d is a corrupted spot. In order to detect and invalidate corrupted pixels or spots the reflectance sharpening filter, which yields the filtered reflectance, as described above may be used. The invalidation may only be applied to pixels that are detected, as corrupted pixels. Pixels may be detected as corrupted pixels only if they are checked beforehand to have a low confidence (intensity) and of the filtered reflectance value is below zero. Thereby, it is possible to avoid over or under-sharpening which results on removing valid pixels or keeping unreliable ones. The detection and invalidation of corrupted pixels based on the reflectance sharpening filter applied to a reflectance image utilizes the fact that the reflectance image has sharper edges compared to the confidence image and the fact that the reflectance has the property of having a pseudo edge at the boundary of the unambiguous range. A reflectance sharpening filter using the reflectance image can identify more accurately the corrupted pixels, wherein better accuracy means being able to properly invalidate (mask) bad pixels and minimizing the erroneous determination of valid pixels as invalid, i.e., improving True-Positive and False-Negative. Other methods for detecting corrupted pixels may use unsharp mask methods, which often use a combination of depth and confidence values to detect the corrupted pixels. These methods often result in over or under-sharpening which results on removing valid pixels or keeping unreliable ones.

FIG. 8 shows the flowchart of detecting a corrupted depth measurement of a pixel in a full field iToF system based on reflectance sharpening filter. At 801, a filtered reflectance value \tilde{r} and confidence value conf of a pixel is received (see FIG. 3). At 802, it is asked if the confidence value conf of the pixel is smaller than a first threshold c₁. The first threshold c₁ may be for example 1-10. If the answer at 802 is no, it is proceeded further with step 805. If the answer at 802 is yes, it is proceeded further with step 803. At 803, it, is asked if filtered reflectance value \tilde{r} for the pixel is smaller than zero. If the answer at 803 is no, it is proceeded further with step 805. If the answer at 802 is yes, it is proceeded further with step 804. At 804, the depth measurement of the pixel d is invalidated. At 805 the process ends.

A pixel which delivers a false depth measurement d is a corrupted pixel. If the answer at 803 and 804 is yes, a corrupted spot is detected (or the probability for a corrupted pixel is very high). A depth measurement d of a pixel may be invalidated by setting the measured depth d delivered by this pixel to zero or to not-a-number (NaN). The pixel may be also invalidated by setting the measured depth value delivered by the pixel to a predetermined value, or to the value of a neighboring pixel. The process of FIG. 8 may be performed for each pixel of the image sensor 102.

FIG. 9 shows the flowchart of detecting a corrupted (false) depth measurement of a spot in a spot ToF system based on reflectance sharpening filter. At 901, a filtered reflectance value \tilde{r}_{S} and confidence value conf_{S} of a spot (i.e. the pixel peak value of a spot) is received (see FIG. 6). At 902, it is asked if the confidence value conf_{S} for the spot (i.e. the pixel peak value of a spot) is smaller than a second threshold c₂. The second threshold c₂ may be for example 1.0-10 (this may depend on a spatial filter strength before thresholding. If a spatial filter is applied, a small value for the confidence threshold may be used, because a “pseudo-confidence” may be removed coming from random noise). If the answer at 902 is no, it is proceeded further with step 905. If the answer at 902 is yes, it is proceeded further with step 903. At 903, it is asked if the filtered reflectance [symbol] value of the spot (i.e. the pixel peak value of the spot) is smaller than zero. If the answer at 903 is no, it is proceeded further with step 905. If the answer at 902 is yes, it is proceeded further with step 904. At 904, the dept measurement d of the spot is invalidated. At 905 the process ends.

A spot whose pixel peak value delivered a false depth measurement d is a corrupted spot. If the answer at 903 and 904 is yes, a corrupted spot is detected (or the probability for a corrupted spot is very high. A spot may be invalidated by setting the measured depth values of all pixels in the corresponding spot pixel region to zero or to not-a-number (NaN). The spot may be also invalidated by setting the measured depth values of all pixels in the corresponding spot pixel region to a predetermined value, or to the value of a neighboring spot. The process of FIG. 9 may be performed for each spot, that is for each spot peak pixel captured by the image sensor 102.

### Implementation

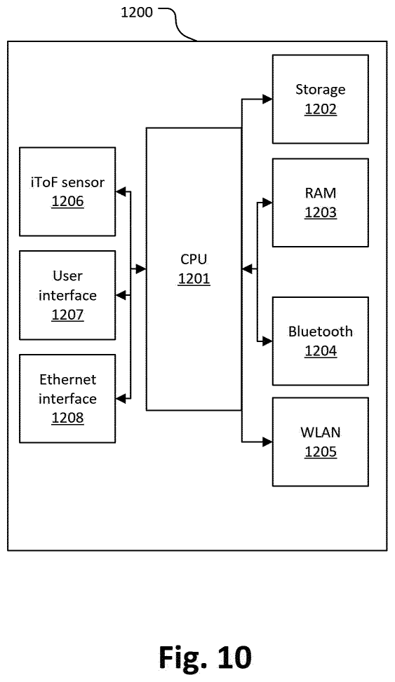

FIG. 10 schematically describes an embodiment of an iToF device that can implement the processes of detecting a corrupted depth measurement of a spot or a pixel in an iToF system. The electronic device 1200 may further implement all other processes of a standard iToF/spot ToF system, like I-Q value determination, phase, amplitude, confidence and reflectance determination. The electronic device 1200 may further implement a DGS algorithm and reflectance sharpening filter. The electronic device 1200 comprises a CPU 1201 as processor. The electronic device 1200 further comprises an iToF sensor 1206 connected to the processor 1201. The processor 1201 may for example implement detecting a corrupted depth measurement of s spot/pixel that realizes the process described with regard to FIG. 8 or FIG. 9 in more detail. The electronic device 1200 further comprises a user interface 1207 that is connected to the processor 1201. This user interface 1207 acts as a man-machine interface and enables a dialogue between an administrator and the electronic system. For example, an administrator may make configurations to the system using this user interface 1207. The electronic device 1200 further comprises a Bluetooth interface 1204, a WLAN interface 1205, and an Ethernet interface 1208. These units 1204, 1205 act as I/O interfaces for data communication with external devices. For example, video cameras with Ethernet, WLAN or Bluetooth connection may be coupled to the processor 1201 via these interfaces 1204, 1205, and 1208. The electronic device 1200 further comprises a data storage 1202, which may be the calibration storage described with regards to FIG. 7, and a data memory 1203 (here a RAM). The data storage 1202 is arranged as a long-term storage, e.g. for storing the algorithm parameters for one or more use-cases, for recording iToF sensor data obtained from the iToF sensor 1206 the like. The data memory 1203 is arranged to temporarily store or cache data or computer instructions for processing by the processor 1201.

It should be noted that the description above is only an example configuration. Alternative configurations may be implemented with additional or other sensors, storage devices, interfaces, or the like.

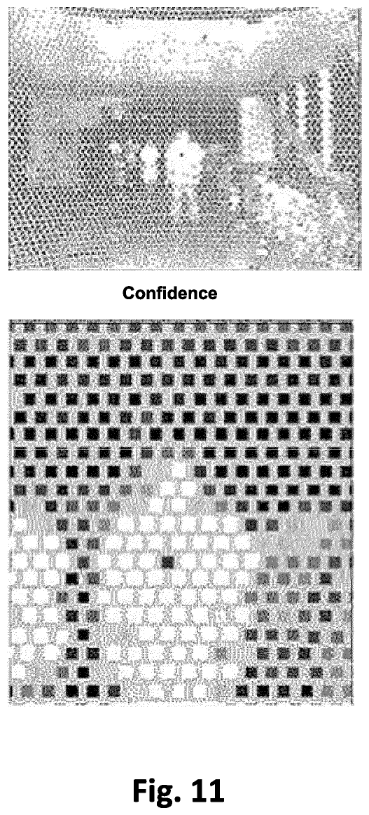

FIG. 11 shows a confidence image captured with a spot ToF camera. The upper part of FIG. 11 shows a confidence image of a scene captured with a spot ToF camera. The lower part of FIG. 11 shows a confidence image with zoomed-in region of interest from the upper confidence image, wherein the zoomed-in region of interest shows the head of a human.

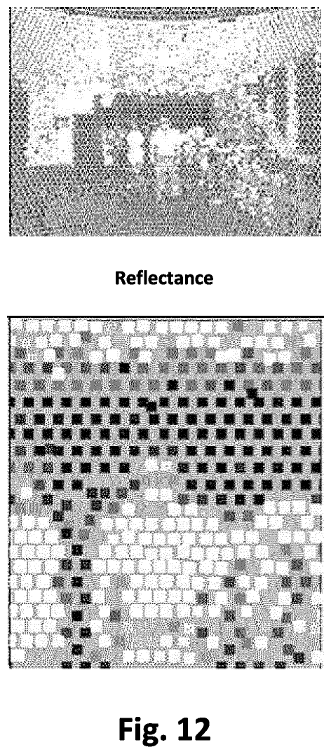

FIG. 12 shows a reflectance image captured with a spot ToF camera. The upper part of FIG. 12 shows a reflectance image of the same scene as in FIG. 11 captured with a spot ToF camera. The lower part of FIG. 12 shows a reflectance image with the same zoomed-in region of interest as in FIG. 11 from the upper reflectance image, wherein the zoomed-in region of interest shows the head of a human.

When comparing confidence image of FIG. 11 to the reflectance image of FIG. 12, which captured the same scene, it can be recognized that the edges are sharper in the reflectance image of FIG. 12.

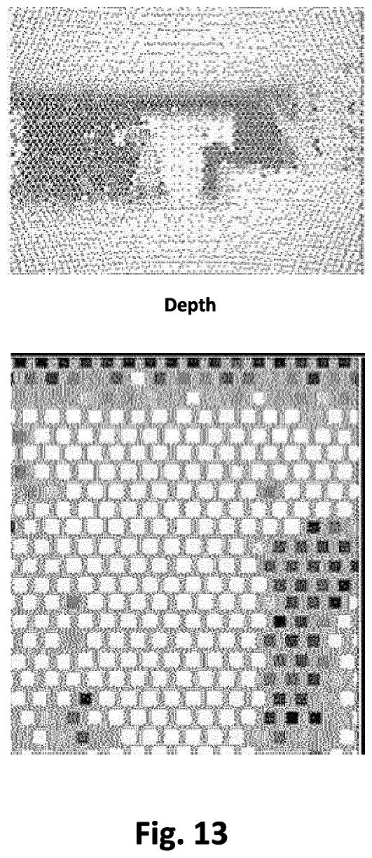

FIG. 13 shows a depth image captured with a spot ToF camera. The upper part of FIG. 13 shows a depth image of the same scene as in FIG. 11 captured with a spot ToF camera. The lower part of FIG. 13 shows a depth image with the same zoomed-in region of interest as in FIG. 11 from the upper depth image, wherein the zoomed-in region of interest shows the head of a human.

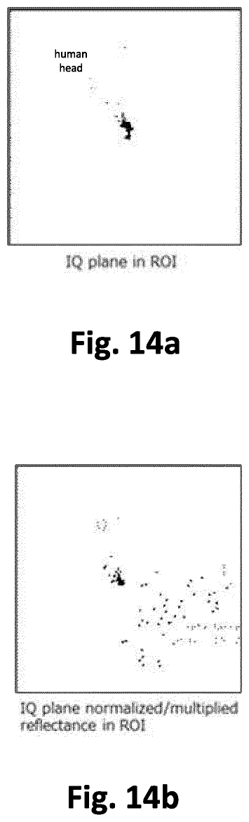

FIG. 14a shows I-Q values of pixels from a region of interest. The I-Q values of the spots (pixels) from the zoomed-in region of interest from FIGS. 11-13 are shown.

FIG. 14b shows multiplied I-Q values of pixels from a region of interest. The I-Q values of the spots (pixels) from the zoomed-in region of interest from FIGS. 11-13 are shown, wherein compared to FIG. 14a, in this case the I-Q values of the spots (pixels) are multiplied with a reflectance value. It can be seen that the reflectance has a large edge at the unambiguous range boundary.

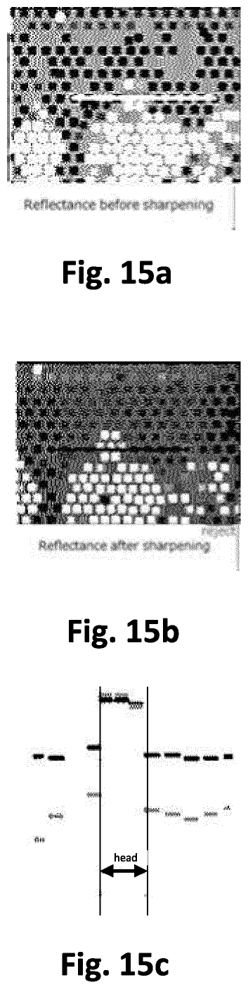

FIG. 15a shows a reflectance image of a region of interest before applying a reflectance sharpening filter. The reflectance values of the spots (pixels) from the zoomed-in region of interest from FIGS. 11-13 are shown.

FIG. 15b shows a reflectance image of a region of interest after applying a reflectance sharpening filter. The filtered reflectance values of the spots (pixels) from the zoomed-in region of interest from FIGS. 11-13, after applying a applying a reflectance sharpening filter, are shown.

FIG. 15c shows a filtered reflectance value of spots. The x-axis shows pixel coordinates and the y-axis shows a reflectance. The lighter dots show the reflectance values of the spots (pixels) along the light line through the middle of FIG. 15a. The darker dots show the filtered reflectance values of the spots (pixels) along the darker line through the middle of FIG. 15b. Both lines, the lighter line through the middle FIG. 15a and the darker line through the middle FIG. 15b correspond to the same spots (pixels) respectively before and after applying the sharpening filter. It can be seen, that several darker dots, after applying the reflectance sharpening filter have a negative filtered reflectance value and are therefore detected as corrupted spots (pixels) and invalidated.

It should be recognized that the embodiments describe methods with an exemplary ordering of method steps. The specific ordering of method steps is, however, given for illustrative purposes only and should not be construed as binding.

It should also be noted that the division of the electronic device of FIG. 10 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated, otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below:
(1) An electronic device (1200) comprising circuitry configured to apply a reflectance sharpening filter to a reflectance image (r; r_{S}) obtained according to an indirect Time-of-Flight, iToF, principle to obtain a filtered reflectance value (\tilde{r}; \tilde{r}_{S}) for a pixel of the reflectance image.
(2) The electronic device (1200) of (1), wherein the circuitry is configured to decide based on the filtered reflectance value (\tilde{r}; \tilde{r}_{S}) of the pixel whether a depth measurement (d) of the pixel is false or not.
(3) The electronic device (1200) of (2), wherein the circuitry is configured to decide that a depth measurement (d) of the pixel is false if the filtered reflectance value [symbol] of the pixel is below zero.
(4) The electronic device (1200) of anyone of (1) to (3), wherein the circuitry is configured to determine a confidence (conf) for the pixel, and to decide whether a depth measurement (d) of the pixel is false or not based on the filtered reflectance value (\tilde{r}; \tilde{r}_{S}) of the pixel and based on the confidence (conf) of the pixel.
(5) The electronic device (1200) of (4 wherein the circuitry is configured to decide that a depth measurement (d) of the pixel is false if the confidence (conf) of the pixel is below a predetermined threshold (c₁; c₂) and if the filtered reflectance value (\tilde{r}; \tilde{r}_{S}) of the pixel is below zero.
(6) The electronic device (1200) of anyone of (1) to (5), wherein the circuitry is configured to invalidate a depth measurement (d) of the pixel based on the filtered reflectance value (\tilde{r}; \tilde{r}_{S}) of the pixel.
(7) The electronic device of anyone of (1) to (6), wherein the filtered reflectance value (\tilde{r}; \tilde{r}_{S}) of the pixel is determined based on the reflectance values (r, rⱼ) of pixels in the reflectance image, and a predetermined sharpening factor (α).
(8) The electronic device of anyone of (1) to (7), wherein applying the sharpening filter to the reflectance image comprises determining a mean reflectance

$$( \frac{1}{N} {\sum }_{j ∈ Ω} {r}_{j} )$$

of pixels (rⱼ) of the reflectance image in the neighborhood (Ω) of the pixel.
(9) The electronic device of anyone of (1) to (8), wherein the reflectance sharpening filter s determined as

$$\tilde{r} = r + α ( r - \frac{1}{N} {\sum }_{j ∈ Ω} {r}_{j} )$$

wherein r is the reflectance value of a pixel in the reflectance image, \tilde{r} is the filtered reflectance value of this pixel, α is a predetermined sharpening factor, Ω is a kernel of the reflectance sharpening filter, N=|Ω| is the number of elements within the kernel Ω of the reflectance, and rⱼ are the reflectance values of pixels j within the reflectance image.
(10) The electronic device (1200) of anyone of (1) to (9), wherein the circuitry is further configured to identify spots captured by an iToF sensor, and wherein each pixel of the reflectance image (r_{S}) is associated with a respective spot of the spots captured by the iToF sensor.
(11) The electronic device (1200) of anyone of (1) to (10), wherein the circuitry is further configured to identify spots captured by an iToF sensor, wherein the pixel is a spot peak pixel of a respective spot of the spots captured by the iToF sensor, and wherein the kernel of the reflectance sharpening filter (Ωₛ) comprises a predetermined number of spots (|Ωₛ|) wherein each spot corresponds to a spot peak pixel.
(12) The electronic device (1200) of (10), wherein the circuitry is configured to invalidate all depth measurements (d) related to a spot of the spots captured by an iToF sensor based on the filtered reflectance value [symbol] of the pixel.
(13) The electronic device (1200) of (11), wherein the circuitry is configured to determine a confidence (conf) for the spot peak pixel, and to decide whether a depth measurement (d) of the spot peak pixel is false or not if the confidence (conf) is below a predetermined threshold (c₁; c₂) and the filtered reflectance value (\tilde{r}_{S}) of the spot peak pixel is below zero.
(14) The electronic device (1200) of (13), which further comprises an image sensor.
(15) The electronic device (1200) of anyone of (1) to (12), which further comprises a spot illuminator.
(16) A method comprising applying a reflectance sharpening filter to a reflectance image (r; r_{S}) obtained according to an indirect Time-of-Flight, iToF, principle to obtain a filtered reflectance value (\tilde{r}; \tilde{r}_{S}) for a pixel of the reflectance image.

1. An electronic device comprising circuitry configured to apply a reflectance sharpening filter to a reflectance image obtained according to an indirect Time-of-Flight, iToF, principle to obtain a filtered reflectance value for a pixel of the reflectance image.

2. The electronic device of claim 1, wherein the circuitry is configured to decide based on the filtered reflectance value of the pixel whether a depth measurement of the pixel is false or not.

3. The electronic device of claim 2, wherein the circuitry is configured to decide that a depth measurement of the pixel is false if the filtered reflectance value of the pixel is below zero.

4. The electronic device of claim 1, wherein the circuitry is configured to determine a confidence for the pixel, and to decide whether a depth measurement of the pixel is false or not based on the filtered reflectance value of the pixel and based on the confidence of the pixel.

5. The electronic device of claim 4, wherein the circuitry is configured to decide that a depth measurement of the pixel is false if the confidence of the pixel is below a predetermined threshold and if the filtered reflectance value of the pixel is below zero.

6. The electronic device of claim 1, wherein the circuitry is configured to invalidate a depth measurement of the pixel based on the filtered reflectance value of the pixel.

7. The electronic device of claim 1, wherein the filtered reflectance value of the pixel is determined based on the reflectance values, of pixels in the reflectance image, and a predetermined sharpening factor.

8. The electronic device of claim 1, wherein applying the sharpening filter to the reflectance image comprises determining a mean reflectance of pixels of the reflectance image in the neighborhood of the pixel.

9. The electronic device of claim 1, wherein the reflectance sharpening filter is determined as
$$\tilde{r} = r + α ( r - \frac{1}{N} {\sum }_{j ∈ Ω} {r}_{j} )$$
wherein r is the reflectance value of a pixel ;in the reflectance image, \tilde{r} is the filtered reflectance value of this pixel, α is a predetermined sharpening factor, Ω is a kernel of the reflectance sharpening filter, N=|Ω| is the number of elements within the kernel Ω of the reflectance, and rⱼ are the reflectance values of pixels j within the reflectance image.

10. The electronic device of claim 1, wherein the circuitry is further configured to identify spots captured by an iToF sensor, and wherein each pixel of the reflectance image is associated with a respective spot of the spots captured by the iToF sensor.

11. The electronic device of claim 1, wherein the circuitry is further configured to identify spots captured by an iToF sensor, wherein the pixel is a spot peak pixel of a respective spot of the spots captured by the iToF sensor, and wherein the kernel of the reflectance sharpening filter comprises a predetermined number of spots wherein each spot corresponds to a spot peak pixel.

12. The electronic device of claim 10, wherein the circuitry is configured to invalidate all depth measurements related to a spot of the spots captured by an iToF sensor based on the filtered reflectance value of the pixel.

13. The electronic device of claim 11, wherein the circuitry is configured to determine a confidence for the spot peak pixel, and to decide whether a depth measurement of the spot peak pixel is false or not if the confidence is below a predetermined threshold and the filtered reflectance value of the spot peak pixel is below zero.

14. The electronic device of claim 1, which further comprises an image sensor.

15. The electronic device of claim 1, which further comprises a spot illuminator.

16. A method comprising applying a reflectance sharpening filter to a reflectance image obtained according to an indirect Time-of-Flight, iToF, principle to obtain a filtered reflectance value for a pixel of the reflectance image.
